(19) United States
(12) Patent Application Publication
(10) Pub. No.: US 2004/0189886 A1
(43) Pub. Date: Sep. 30, 2004

(54) Structure for absorbing the shock

(76) Inventors: Chia-Lin Chang, Taipei City (TW); Chun-Chung Pai, Taipei Hsien (TW); Ming-Xia Yang, Nantou (TW)

Correspondence Address: PERKINS COIE LLP, PATENT-SEA, P.O. BOX 1247, SEATTLE, WA, 98111-1247, US

(21) Appl. No.: 10/428,241

(22) Filed: May 2, 2003

(30) Foreign Application Priority Data
Mar. 28, 2003 (TW) 092204905

(51) Int. Cl. G02F 1/1333

(52) U.S. Cl. 349/58

(57) ABSTRACT

It is an object of the present invention to provide a structure for absorbing the shock. The structure comprises a buffer assembly and a screen device. The buffer assembly is combined with the screen device, and the buffer assembly can avoid the screen device cracking in the structure for absorbing the shock colliding. Another, the present invention provides an electric device structure for absorbing the shock. The electric device structure comprises a set of LCD bracket having a plurality of buffer cushions, a Liquid Crystal Display Module (LCM) combining with the set of LCD bracket, and an electric device mainframe for being fixed by the Liquid Crystal Display Module. The plurality of buffer cushions of the set of LCD bracket can avoid the Liquid Crystal Display Module cracking in the electric device colliding. The electric device includes but not limits a WEBPAD or a related product of Tablet PC.

### CROSS-REFERENCE TO RELATED APPLICATION

This application claims priority to Taiwan Patent Application No. 092204905, filed Mar. 28, 2003, which is incorporated herein in its entirety by reference.

### TECHNICAL FIELD

The present invention relates to a structure for absorbing the shock, and specifically, to a providing the structure for absorbing the shock for a electric device, thereby avoiding the Liquid Crystal Display Module (LCM) cracking in the electric device colliding.

### BACKGROUND

Currently, science and technology changing with each passing day, a powerfully electric device, for example personal computer (PC), is become to a popular application device. The personal computer (PC) is commonly comprised a desktop computer and a laptop computer. There is a tendency that the desktop computer is replaced with the laptop computer for smaller volume and suitable carrying. The laptop computer includes a screen device. A Liquid Crystal Display Module (LCM) is generally used as the screen device, and the Liquid Crystal Display Module (LCM) includes a TFT LCD and a peripheral device. The fixing method of the Liquid Crystal Display Module (LCM) is generally fixed by using a common screw locking tightly onto the peripheral device of the Liquid Crystal Display Module (LCM). Therefore, the Liquid Crystal Display Module (LCM) may be cracked by the Liquid Crystal Display Module (LCM) colliding. Of course, others portable electric devices are similar to the same as above.

It is convenient for the portable electric devices to carry and take, and therefore adds the number of times of carrying the portable electric devices with users outside. Moreover, for these users necessary carrying the portable electric devices everyday in working, the portable electric devices protection is an important task or challenge. Specially, the protection equipment of the portable electric devices needs a function of waterproof and shockproof.

The portable electric device is taken out using from the protection equipment. If the portable electric devices is to be colliding or impacting, as a result of the fixing method of the Liquid Crystal Display Module (LCM) by using a common screw locking tightly onto the peripheral device of the Liquid Crystal Display Module (LCM) and no other shock absorber, the Liquid Crystal Display Module (LCM) can not avoid the Liquid Crystal Display Module (LCM) cracking in colliding or impacting. Thus, users must spend a additional cost to buy the Liquid Crystal Display Module (LCM) to recover the portable electric devices function.

The present invention is provided a suitable structure, it can avoid the Liquid Crystal Display Module (LCM) cracking in colliding or impacting.

### SUMMARY

The object of the present invention is to provide a structure for absorbing the shock by using a buffer assembly to avoid the screen device cracking in the structure for absorbing the shock colliding. The structure for absorbing the shock of the present invention can apply various electric devices, for example a WEBPAD or a related product of Tablet PC.

The structure for absorbing the shock, comprising: a buffer assembly; and, a screen device combining with the buffer assembly; wherein the buffer assembly can avoid the screen device cracking in the structure for absorbing the shock colliding.

The structure for absorbing the shock, comprising: a set of LCD bracket having a plurality of buffer cushions; a Liquid Crystal Display Module (LCM) combining with the set of LCD bracket; and, wherein the plurality of buffer cushions of the buffer set of LCD bracket can avoid the Liquid Crystal Display Module (LCM) cracking in the structure for absorbing the shock colliding.

The electric device structure for absorbing the shock, comprising: a set of LCD bracket having a plurality of buffer cushions; a Liquid Crystal Display Module (LCM) combining with the set of LCD bracket; and, an electric device mainframe for being fixed by the Liquid Crystal Display Module; wherein the plurality of buffer cushions of the buffer set of LCD bracket can avoid the Liquid Crystal Display Module (LCM) cracking in the electric device structure for absorbing the shock colliding.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic illustration of set of the LCD bracket and the Liquid Crystal Display Module (LCM) of the structures for absorbing the shock in accordance with the present invention.

FIG. 2 is a schematic illustration of the rubber cushions of the structures for absorbing the shock in accordance with the present invention.

FIG. 3 is a schematic illustration of set of the LCD bracket, the Liquid Crystal Display Module (LCM) and the electric device mainframe of the electric device structures for absorbing the shock in accordance with the present invention.

FIG. 4 is a schematic illustration of fixing method of the Liquid Crystal Display Module (LCM) with the electric device mainframe of the electric device structures for absorbing the shock in accordance with the present invention.

### DETAILED DESCRIPTION

The present invention discloses a structure for absorbing the shock by using a buffer assembly to avoid the screen device cracking in the structure for absorbing the shock colliding. The preferred embodiment of the present invention can be illustrated by the following description.

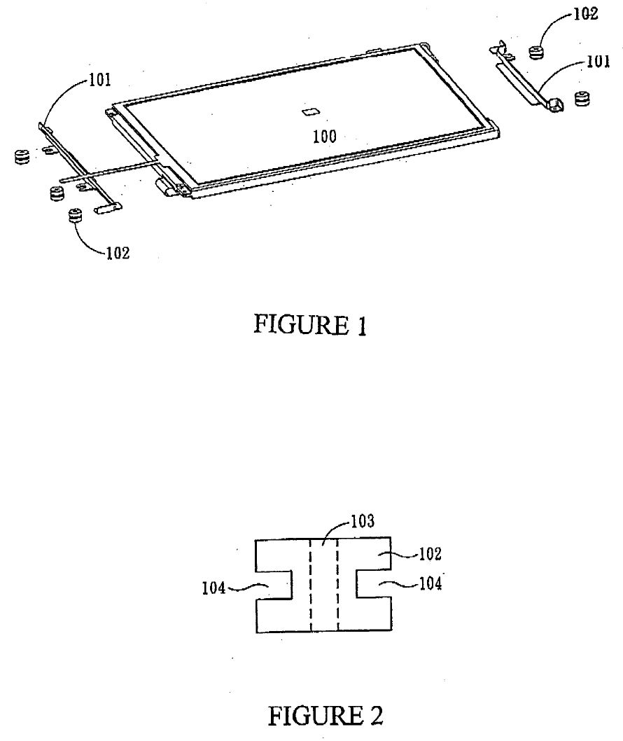

Turning to FIG. 1, is a schematic illustration of set of the LCD bracket and the Liquid Crystal Display Module (LCM) of the structures for absorbing the shock in accordance with the present invention. The Liquid Crystal Display Module (LCM) 100 includes a TFT LCD and a Touch Panel. The number of the set of LCD bracket 101 is two to combine with the Liquid Crystal Display Module (LCM) 100 for suitable moving and fixing of the Liquid Crystal Display Module (LCM) 100. A plurality of rubber cushions 102 is located on the side of the set of LCD bracket 101. The rubber cushions are the cylinder structure having a hollow cylinder 103 extending from top to bottom of the cylinder structure and concave ring 104 in the cylinder structure side, referring to FIG. 2.

The two of LCD bracket 101 have a plurality of locking troughs (not shown). The protruding part (not shown) of two of LCD bracket 101 are used to insert into the fillister (not shown) of the Liquid Crystal Display Module (LCM) 100. The locking troughs of the set of LCD bracket 101 lock the concave ring of the rubber cushions 102 to form the structure for absorbing the shock, after the set of LCD bracket 101 combining with the Liquid Crystal Display Module (LCM) 100.

The plurality of buffer cushions 102 have a buffer function to avoid the Liquid Crystal Display Module (LCM) 100 cracking in the structure for absorbing the shock colliding.

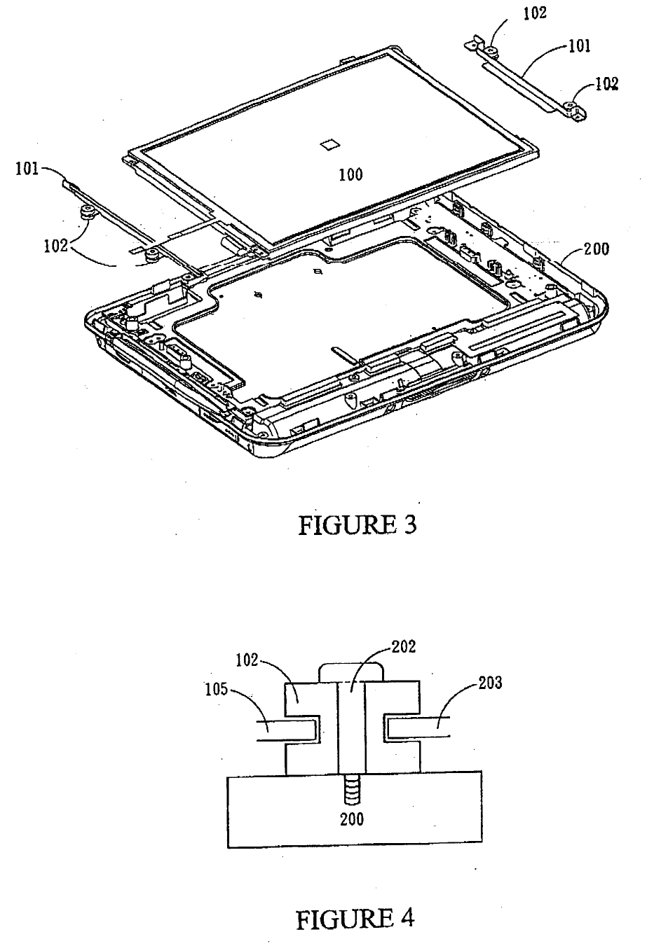

FIG. 3 is a schematic illustration of set of the LCD bracket, the Liquid Crystal Display Module (LCM) and the electric device mainframe of the electric device structures for absorbing the shock in accordance with the present invention. The formed structure for absorbing the shock is fixed the electric device mainframe 200 of the electric device structures for absorbing the shock. The electric device includes but not limits a WEBPAD or a related product of Tablet PC.

FIG. 4 is a schematic illustration of fixing method of the Liquid Crystal Display Module (LCM) with the electric device mainframe of the electric device structures for absorbing the shock in accordance with the present invention. Next, the hollow cylinder 103 of the rubber cushions 102 is placed by a plurality of special screws 202 after forming structure for absorbing the shock, locking tightly the special screws 202 to fasten the Liquid Crystal Display Module 100 onto the electric device mainframe 200, thereby forming the electric device structure for absorbing the shock.

Therefore, the one side of the rubber cushions 102 is lucked by the locking troughs 105 of the set of LCD bracket 101 extending concave ring 104, and the other side of the rubber cushions 102 is locked by the locking troughs 203 of the electric device mainframe 200 extending concave ring 104. For the plurality of special screws 202, the locking troughs 105 of the set of LCD bracket 101 and the locking troughs 203 of the electric device mainframe 200 locking tightly, the Liquid Crystal Display Module 100 will fasten tightly onto the electric device mainframe 200.

The plurality of buffer cushions 102 have a buffer function to avoid the Liquid Crystal Display Module (LCM) 100 cracking in the electric device structure for absorbing the shock colliding.

As the above illustrated, the electric device structure for absorbing the shock of the present invention is used to a fixing method and a buffer assembly to avoid the Liquid Crystal Display Module (LCM) cracking the electric device structure for absorbing the shock colliding.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

I/We claim:

1. A structure for absorbing the shock, comprising:
a buffer assembly; and
a screen device combining with said buffer assembly;
wherein said buffer assembly can avoid said screen device cracking in said structure for absorbing the shock colliding.

2. The structure of claim 1, wherein said screen device includes a Liquid Crystal Display Module (LCM).

3. The structure of claim 2, wherein said Liquid Crystal Display Module (LCM) includes a TFT LCD and a Touch Panel.

4. The structure of claim 1, wherein said buffer assembly includes a set of LCD bracket and a plurality of buffer cushions

5. The structure of claim 4, wherein said plurality of buffer cushions are rubber cushions.

6. The structure of claim 5, wherein said rubber cushions are the cylinder structure having a hollow cylinder extending from top to bottom of said cylinder structure and concave ring in said cylinder structure side.

7. The structure of claim 4, wherein the number of said set of LCD bracket is two located on two side of said Liquid Crystal Display Module (LCM), and combined with said Liquid Crystal Display Module (LCM).

8. The structure of claim 4, wherein said set of LCD bracket has a plurality of locking troughs.

9. The structure of claim 7, wherein said locking troughs of said set of LCD bracket lock said concave ring of said rubber cushions structure to form said structure for absorbing the shock, after said set of LCD bracket combining with said Liquid Crystal Display Module (LCM).

10. A structure for absorbing the shock, comprising:
a set of LCD bracket having a plurality of buffer cushions;
a Liquid Crystal Display Module (LCM) combining with said set of LCD bracket; and
wherein said plurality of buffer cushions of said buffer set of LCD bracket can avoid said Liquid Crystal Display Module (LCM) cracking in said structure for absorbing the shock colliding.

11. The structure of claim 10, wherein said Liquid Crystal Display Module (LCM) includes a TFT LCD and a Touch Panel.

12. The structure of claim 10, wherein said plurality of buffer cushions are rubber cushions.

13. The structure of claim 12, wherein said rubber cushions are the cylinder structure having a hollow cylinder extending from top to bottom of said cylinder structure and concave ring in said cylinder structure side.

14. The structure of claim 10, wherein the number of said set of LCD bracket is two located on two side of said Liquid Crystal Display Module (LCM), and combined with said Liquid Crystal Display Module (LCM).

15. The structure of claim 10, wherein said set of LCD bracket has a plurality of locking troughs.

16. The structure of claim 10, wherein said locking troughs of said set of LCD bracket lock said concave ring of said rubber cushions structure to form said structure for absorbing the shock, after said set of LCD bracket combining with said Liquid Crystal Display Module (LCM).

17. A electric device structure for absorbing the shock, comprising:
a set of LCD bracket having a plurality of buffer cushions;
a Liquid Crystal Display Module (LCM) combining with said set of LCD bracket; and
an electric device mainframe for being fixed by said Liquid Crystal Display Module;
wherein said plurality of buffer cushions of said buffer set of LCD bracket can avoid said Liquid Crystal Display Module (LCM) cracking in said electric device structure for absorbing the shock colliding.

18. The structure of claim 17, wherein said electric device is a WEBPAD.

19. The structure of claim 17, wherein said electric device is a related product of Tablet PC.

20. The structure of claim 17, wherein said Liquid Crystal Display Module (LCM) includes a TFT LCD and a Touch Panel.

21. The structure of claim 17, wherein said plurality of buffer cushions are rubber cushions.

22. The structure of claim 21, wherein said rubber cushions are the cylinder structure having a hollow cylinder extending from top to bottom of said cylinder structure and concave ring in said cylinder structure side.

23. The structure of claim 17, wherein the number of said set of LCD bracket is two located on two side of said Liquid Crystal Display Module (LCM), and combined with said Liquid Crystal Display Module (LCM).

24. The structure of claim 17, wherein said set of LCD bracket has a plurality of locking troughs.

25. The structure of claim 23, wherein said locking troughs of said set of LCD bracket lock said concave ring of said rubber cushions structure after said set of LCD bracket combining with said Liquid Crystal Display Module (LCM), using a fixed device inserting into said hollow cylinder of said rubber cushions to fix said Liquid Crystal Display Module onto said electric device mainframe, thereby forming said electric device structure for absorbing the shock.

26. The structure of claim 25, wherein said fixed device is a plurality of special screws.
